(19) United States
(12) Patent Application Publication
(10) Pub. No.: US 2006/0029114 A1
(43) Pub. Date: Feb. 9, 2006

(54) Semiconductor laser device

(75) Inventors: Hiroshi Kohda, Yokohama-shi (JP); Hiroshi Suganuma, Yokoham-shi (JP); Koji Nakazato, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES, LTD.

(21) Appl. No.: 11/193,416

(22) Filed: Aug. 1, 2005

(30) Foreign Application Priority Data
Aug. 5, 2004 (JP) 2004-229028

(51) Int. Cl. H01S 3/04

(52) U.S. Cl. 372/34; 372/43.01

(57) ABSTRACT

Provided is a semiconductor laser device having an economical structure in which the replacement of a semiconductor laser module is easy and in which the occurrence of dew condensation can be prevented while the increase in the lifetime as well as the stabilization and high output of laser output can be accomplished. The semiconductor laser device comprises semiconductor laser modules; a container main body which accommodates the semiconductor laser modules and which has an opening for taking out a semiconductor laser module outside; a lid provided at the opening in an openable and closable manner; and a means for cooling the semiconductor laser modules.

### BACKGROUND OF THE INVENTION

1. Field of the Invention

The present invention relates to a semiconductor laser device which is provided with a countermeasure against dew condensation.

2. Description of the Background Art

A semiconductor laser module used in a semiconductor laser device generates heat simultaneously with laser output. When the temperature of the laser module rises, the strength of output light is decreased. Therefore, it is necessary to cool the laser module to keep the optical strength constant; the temperature must be maintained constant in the range of ±1° C. at a given temperature in the range of 25° C. to 35° C. When the laser module is cooled, a countermeasure against dew condensation must be provided so that various troubles may not be caused with the dew condensation.

As for dew condensation countermeasures, a semiconductor laser module disclosed in Japanese Patent Application Publication No. Sho-56-42389 has a completely airtight sealing structure, and a laser module disclosed in Japanese Patent Application Publication No. 2000-40850 is such that dew condensation is prevented by increasing the temperature of the semiconductor laser module itself by means of flowing an electric current below a predetermined threshold value.

However, in the case of a semiconductor laser device having semiconductor laser modules housed in a container, it is costly to provide welding facilities to make an airtight sealing structure itself if a completely airtight sealing structure is to be made by welding. In addition, it is impossible to exchange the broken laser module without destroying the container if at least one semiconductor laser module is broken.

In the past, therefore, a failure of at least one semiconductor laser module has been treated as if it were a failure of the whole laser device such that the whole laser device was disposed. However, in the case of a laser device equipped with a plurality of semiconductor laser modules, it is very wasteful to dispose the whole laser device in which at least one semiconductor laser module is broken. Also, in the case where the method of preventing dew condensation by increasing the temperature of a semiconductor laser module itself was adopted, occasionally a predetermined optical output strength could not be obtained or the life of the semiconductor laser device was reduced.

### SUMMARY OF THE INVENTION

An object of the present invention is to provide a semiconductor laser device having an economical structure in which the exchange of a semiconductor laser module is easy and in which the prevention of occurrence of dew condensation can be achieved while the increase in the lifetime as well as the stabilization and high output of laser output can be accomplished.

To achieve such object, a semiconductor laser device according to the present invention comprises semiconductor laser modules; a container main body which accommodates the semiconductor laser modules and which has an opening for taking out a semiconductor laser module outside; a lid provided at the opening in an openable and closable manner; and a means for cooling the semiconductor laser modules.

### BRIEF DESCRIPTION OF THE DRAWINGS

The features, aspects, and advantages of the present invention will be better understood by reference to the following description, appended claims, and the accompanying drawings where:

FIGS. 1A and 1B are schematic diagrams of a semiconductor laser device according to a first embodiment of the present invention; FIG. 1A is a plan view illustrating a state in which a lid is removed, and FIG. 1B is a side sectional view illustrating a state in which a lid is installed;

FIG. 2 is a perspective view of the lid of a semiconductor laser device according to the first embodiment;

FIG. 3 is a schematic diagram (a side sectional view showing a state in which a lid is installed) illustrating another example of the semiconductor laser device according to the first embodiment;

FIGS. 4A and 4B are schematic diagrams of a semiconductor laser device according to a second embodiment of the present invention; FIG. 4A is a plan view illustrating a state in which a lid is removed; FIG. 4B is a side sectional view illustrating a state in which a lid is installed;

FIG. 5 is a schematic diagram (a side sectional view illustrating a state in which a lid is installed) illustrating another example of the semiconductor laser device according to the second embodiment;

FIG. 6 is a schematic diagram illustrating an example of manner of fixing a lid and a container main body in the second embodiment; and

FIGS. 7A and 7B are schematic diagrams illustrating other example of manners of fixing a lid and a container main body in the second embodiment; FIG. 7A is a case where an L-shaped hook is used; FIG. 7N is a case where a seal tape is used.

### DETAILED DESCRIPTION OF THE INVENTION

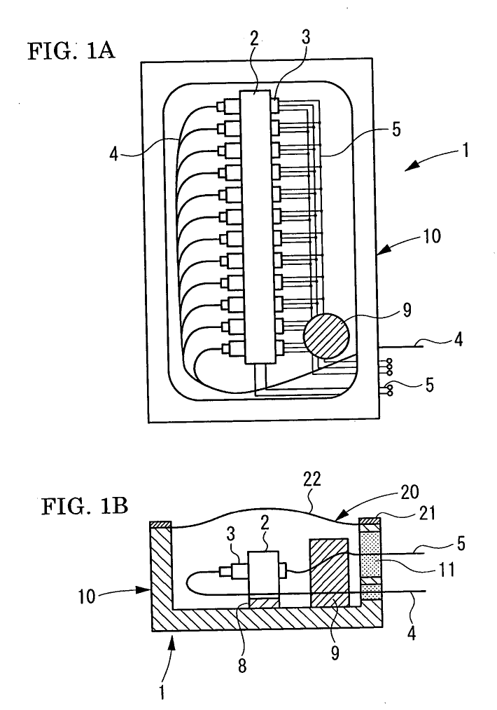

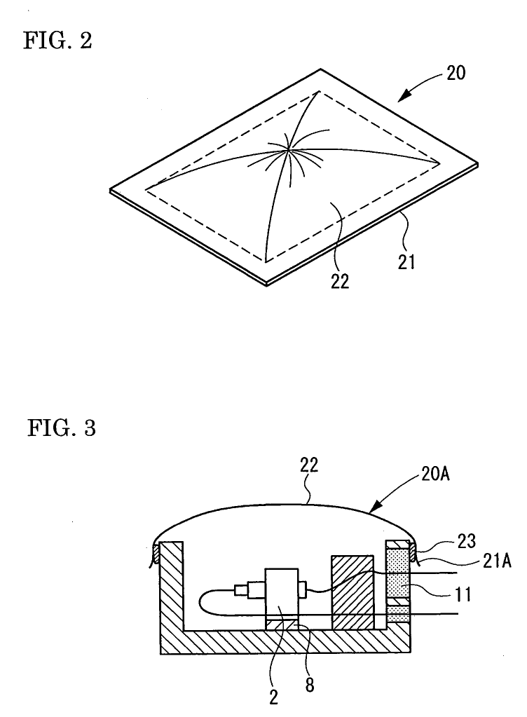

FIGS. 1A and 1B are schematic diagrams of a first embodiment of a semiconductor laser device according to the present invention: FIG. 1A is a plan view illustrating a state in which a lid is removed; FIG. 1B is a side sectional view illustrating a state in which a lid is installed. FIG. 2 is a perspective view of the lid of a semiconductor laser device according to the first embodiment.

A semiconductor laser device 1 houses semiconductor laser modules 3 in a container main body 10, which is sealed up airtight with a lid 20. The container main body 10 is a box with a rectangular parallelepiped form having an open top, and the lid 20 is used to cover the open top. A plurality of laser modules 3 are housed in the container main body 10 in a manner such that they are disposed in a given arrangement and held by a heat conductive holder 2 which is made of a material having an excellent heat conductive property such as aluminum or copper, etc. In the case of the first embodiment, twelve laser modules are accommodated in the container main body 10.

At one end each of the laser modules 3, optical fibers 4 are provided such that the output light beams of the laser modules 3 are guided to be output in a bundled manner by the optical fibers 4, and the other end is connected to electrical wirings 5 that supply electric power to the respective laser modules 3. Inside each of the laser modules 3, there are provided a semiconductor laser element and a lens for collecting output light from the laser element into the input end of the respective optical fiber (neither of them are shown in the figure).

Thus, since light beams emitted from a plurality of laser modules 3 are bundled to be output, it is possible to obtain laser beams having such a high power density or a broad range of power distribution as cannot be obtained with one semiconductor laser module. If a laser device is structured such that a plurality of laser beams are output in a bundled manner as in the first embodiment, there is an advantage in that although the output of the laser modules 3 substantially decreases at an 1000-10000 hour scale of use with the same electric current, it is possible to compensate a decrease in the output of a specific semiconductor laser module with an output increase of other semiconductor laser modules, thereby decreasing the ratio of failures as a whole.

Also, if the output decrease of a specific semiconductor laser module cannot sufficiently be compensated with the output increase of other semiconductor laser modules, only the laser module whose output has decreased can be replaced and the use of the other laser modules can be continued. In the case of using one semiconductor laser module 3, there was a tendency that the failure of the laser module 3 was treated as a failure of the whole device. In the case of using plurality of semiconductor laser module 3, however, there is a merit available by such replacement. In this case, it is required for the laser module 3 to be replaced easily. In the case of the first embodiment, since the container main body 10 is structured such that the whole top face thereof is an opening, it is possible to replace the laser module 3 easily through the opening by removing the lid 20.

Also, in the case of the first embodiment, a means (refrigerator) 8 for cooling the semiconductor laser module 3 at the bottom of the container main body 10 is provided because the semiconductor laser module 3 must be maintained to a low and constant temperature during the output of light in order to obtain constant optical strength continuously or to use it under high temperature and large electric current. In this case, a Peltier device which does not need a refrigerant or the like is used as a refrigerator 8 so that the downsizing of the semiconductor laser device can be devised.

The refrigerator 8 comprising a Peltier device is fixed such that a low-temperature part thereof is in contact with a heat conductive holder 2 while a high-temperature part thereof is in contact with the container main body 10. Accordingly, the heat in the high-temperature part of the refrigerator 8 is transferred through the container main body 10 to the outside environment. Therefore, it is desirable that the container main body 10 be made of a material having high thermal conductivity such as a metal or the like so that the heat of the high-temperature part of the refrigerator 8 may be radiated efficiently. Furthermore, it is desirable that heat radiating members are provided so as to be fixed in contact with the container main body 10. The heat radiating member is a comb-shaped aluminum structure or a heat radiating sheet, for example. The space between these heat radiating members and the container is filled with a grease or the like having an excellent property of thermal conductivity. Moreover, it is preferable to provide a fan motor for sending fresh air to the container main body and the heat radiating members in order to improve the radiation of heat from them.

The heat conductive holder 2, which has a function of efficiently transferring a low temperature generated by the refrigerator 8 to semiconductor laser modules 3, is formed in a shape that allows its close contact with the peripheries of the laser modules 3, in particular at the vicinity of the laser elements which are exothermic sources. The space between the heat conductive holder 2 and the laser modules 3 is filled with a grease or the like having good properties of thermal conductivity. Likewise, a grease or the like having excellent thermal conductiveness is applied on the interface of the heat conductive holder 2 and the low-temperature part of the refrigerator 8 as well as on the interface of the container main body 10 and the high-temperature part of the refrigerator 8.

Moreover, the semiconductor laser device 1 has a desiccant 9 in the container main body 10. For example, a low-cost silica gel is used as the desiccant 9. The desiccant 9 fulfils a function of absorbing the vapor which has penetrated through a part of insufficient airtightness, so that the inner gas is maintained in a dry condition to the extent that the refrigerator 8 does not cause dew condensation. For example, when the laser device 1 is used indoors where there is an air-conditioner in operation, the outside air around the laser device 1 may become high temperature and humid, for example, to 40° C. and a humidity of 80%. Since the dew point at this temperature is 35° C., dew condensation occurs in the laser module 3 if the semiconductor laser module 3 is cooled to a temperature below the dew point. As a result, the dew condensation may cause rust, a failure such as short circuit, etc. Therefore, it is necessary to dry to a humidity level at which the dew point of the cooled part becomes below the cooling temperature.

As described above, the heat conductive holder 2 and the semiconductor laser modules 3 are fixed to the container main body 10 through the refrigerator 8, and moreover the opening at the upper part of the container main body 10 is covered with the lid 20. At least a part of the lid 20 is comprised of a resinous film 22. That is, the lid 20 consists of a frame part 21 made of a hard material and the resinous film 22 having a low coefficient of humidity transmissivity, wherein the frame part 21 is attached to the peripheries of the opening of the container main body 10 and the resinous film 22 is fixed with the frame part 21.

The resinous film 22 has a, flexibility that allows its deformation according to the change in the inner gas pressure of the container main body 10. For example, the resinous film 22 is fixed to the frame part 21 after the resinous film 22 has been formed in a shape of a dome. As a result, when the inner gas causes a pressure change due to temperature variation, the resinous film 22 is transformed such that the internal pressure is maintained in the same condition as the outside air pressure, and consequently even if the airtightness is not complete, the penetration of the outside air is reduced and accordingly the infiltration of vapor from the outside is restrained to a minimum level. Therefore, the quantity of the necessary desiccant 9 can also be reduced. The resinous film 22 may be formed in a bellows-like shape so that its deformation may be secured easily.

The humidity-permeation of the resinous film 22 must be as low as possible. For example, under the following conditions (1) to (6), (the total quantity of water absorption of the silica gel)=80 g×16%=13 g, and (The quantity of moisture permeability of the resinous film)≦13 g÷365 days÷0.04 m²≦1 g/(m²day) since the moisture quantity at a dew point of 15° C. corresponds to the humidity of 25% at 40° C. and the moisture absorption ratio of the silica gel (type A) at a humidity of 25% is about 16% according to JIS-Z0701:

(1) the capacity of the container main body: 20 cm×20 cm×20 cm=8000 cm³;

(2) the area of the resinous film: 0.2 m×0.2 m=0.04 m²;

(3) the temperature of the outside air: 40° C.;

(4) the temperature of the refrigerator: 15° C.;

(5) the quantity of the silica gel: 10% of the capacity of the container main body (80 g); and

(6) the period of the use of the silica gel: 1 year.

Thus, the occurrence of dew condensation at the cooling part can be effectively prevented under the conditions of general use if the coefficient of moisture permeability of the resinous film 22 is 0.5 g/(m²day) or less, for example.

Therefore, suitable materials for the resinous film are general materials such as polyethylene terephthalate coated with silica, aluminum, etc. (the quantity of moisture permeability=0.1-0.2 [g/(m²·day)]), and a polyolefin group resin (the quantity of moisture permeability=0.2-0.6[g/(m²·day)]) since their moisture permeability degree is low.

Thus, the lid 20 whose main part is made of the resinous film 22 is fixed by an adhesive or the like on the surface of the container main body 10, and the inside which is covered with the container main body 10 and the lid 20 is substantially sealed up. Also, the electrical wirings 5 and the optical fibers 4, which are connected with the semiconductor laser modules 3, are drawn out through the wall of the container main body 10, and the part through which they are drawn out is substantially sealed up with an adhesive 11 and the like. Preferably, the container main body 10 is made of a metallic material and the inside of the container main body 10 is filled with a gas.

The semiconductor laser device 1 is structured such that the semiconductor laser modules 3 can be freely exchanged through the opening at the top face of the container main body 10 by opening the lid 20 as needed. Therefore, only a broken semiconductor laser module can be replaced, while the other semiconductor laser modules which are not out of order, as well as the container main body and the means of cooling, can be used for their respective lifetime, whereby the wastefulness can be reduced. In addition, since the semiconductor laser device 1 is equipped with the refrigerator 8 and the desiccant 9, the occurrence of dew condensation at the cooling part can be effectively prevented by the desiccant 9 while the stabilization of laser output and high output and the elongated lifetime can be maintained by cooling.

In the first embodiment, since the most part of the lid 20 is made of the resinous film 22 having a low coefficient of moisture permeability, the lid 20 can easily be deformed according to the shape of the container main body 10 as compared with the case where the lid is made of a hard material of high rigidity such as a metal or resinous board. Accordingly, the sealing of the container main body 10 can easily be made and the lid 20 can easily be removed from the container main body 10. Therefore, the efficiency of the replacement work of the semiconductor laser module 3 can be improved.

Since the lid 20 can be manufactured at low cost because the most part thereof is made of the resinous film 22, the lid 20 may be discarded with relatively small wastefulness of the cost in the case of replacing a semiconductor laser module 3. When a new lid 20 is attached, high sealing effect can be secured by using adhesives for fixing the frame part 21 and the container main body 10.

Since the resinous film 22 constituting the lid 20 is transformed according to change in the inner gas pressure of the container main body 10, there hardly occur differences in the pressure between outside and inside the semiconductor laser device. As a result, even if the container main body 10 is not sealed completely airtight, the outside air is restrained from entering thereinto and accordingly the amount of vapor penetrating into the inside is reduced. Even if a small amount of vapor enters with the outside air, it would not be a problem at all because the vapor will be absorbed by the desiccant 9. Also, the quantity of use of the desiccant and the exchange frequency of the desiccant can be decreased.

In the case where a gas exhibiting high thermal insulation is filled in the container main body 10, the low temperature generated by the refrigerator 8 can be prevented from spreading to the side of the container main body 10 and consequently occurrence of dew condensation at the outer peripheries of the container main body 10 can be prevented. Also, since the spread of the low temperature can be restrained, the low temperature can be used effectively to cool the semiconductor laser modules 3 and the cooling efficiency can be improved. In the case where the container main body 10 is formed of a material having an excellent heat conduction property, the heat of the high-temperature part of a Peltier device used as the refrigerator 8 can effectively be discharged outside through the container main body 10. Also, since the container main body 10 can be maintained at comparatively high temperature, the dew condensation can be prevented from occurring to the outer peripheries of the container main body 10.

FIG. 3 is a schematic diagram (a sectional view illustrating the condition in which a lid is attached) showing another example of the semiconductor laser device according to the first embodiment. In this example, the peripheral part of the resinous film 22 itself is formed to be the frame part 21A, and the lid 20A thus formed is fixed to the container main body 10 with an adhesive material.

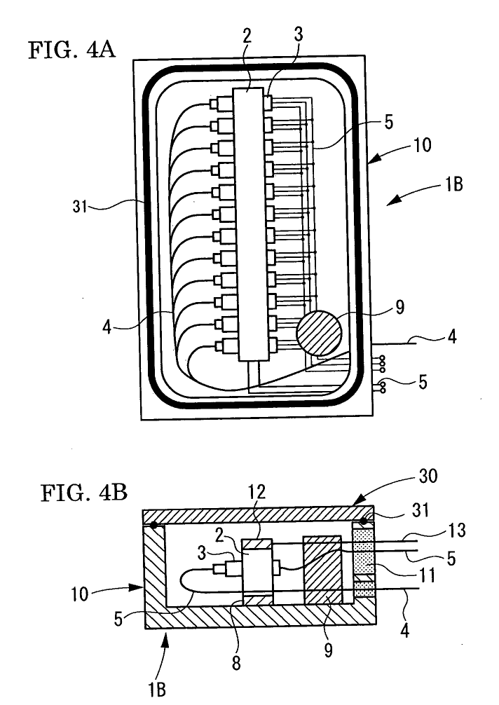

FIGS. 4A and 4B are schematic diagrams of a semiconductor laser device according to a second embodiment of the present invention: FIG. 4A is a plan view illustrating a state in which a lid is removed; FIG. 4B is a side sectional view illustrating a state in which a lid is installed. In the semiconductor laser device 1B of the second embodiment, the lid 30 is made of a hard board material and a sealing means is provided between the container main body 10 and the lid 30. Preferably, the sealing means is made of one of, or two or more combinations of, a grease, a paste-like sealing material, a sealing ring, and a sealing tape. The seal tape is, for example, a tape made of a material such as aluminum having low moisture permeability. In the case of the second embodiment, a sealing ring 31 is used.

The seal ring 31 has a circular cross-section, for example, and is made of a material such as silicone rubber or fluorocarbon rubber (Viton, trade name), etc. Thus, it is possible to maintain high sealing condition. Also, it can be reused for sealing by simply putting it between the interface of the lid and the container main body. A hard board of high rigidity is used for the lid 30 to obtain enhanced airtightness with the sealing ring 31. The material thereof is a metal such as aluminum, a resin such as acrylic, or glass, etc. Transparent materials such as acrylic and glass are preferable because the existence or non-existence of inner dew condensation can be confirmed visually. The moisture permeability of these materials is as low as can be ignored because of their thickness or inherent characteristics. Therefore, the outside air does not permeate through the lid 30 as moisture but enters through an incompletely airtight part. The lid 30 is fixed to the container main body 10 by a clamping means.

The semiconductor laser device has a temperature and humidity sensor 12 provided on the heat conductive holder 2 in the container main body 10. Thus, it is possible to set the laser to OFF-condition when the temperature and humidity exceed the dew point of the cooling part, to control the prevention of dew condensation due to temporary rise of the cooling temperature, and to check whether silica gel should be exchanged.

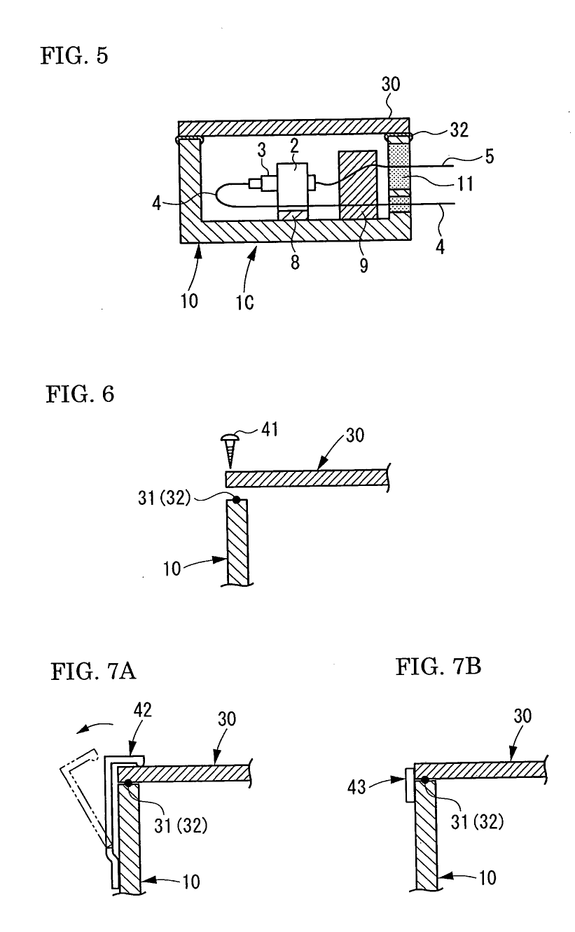

FIG. 5 is a schematic diagram (a side sectional view illustrating a state in which a lid is attached) illustrating another example of the semiconductor laser device according to the second embodiment. As in the case of the semiconductor laser device IC, instead of using the sealing ring 31, a paste-like or grease-like sealing material 32 may be applied between the lower surface of the lid 30 and the upper end of the container main body 10. For example, when a liquid gasket or silicone grease for vacuum is used instead of adhesives, the removal of the lid 30 is easy because these materials have very weak adhesion power or do not have any adhesion power, unlike the adhesives. Also, re-sealing can be accomplished by simply applying them on the matching surfaces of the lid and the container main body. If a seal means is adopted by selecting two or more combinations among a grease, a paste-like sealing material, and a sealing ring, sealing effect can be further enhanced with the synergy effect.

FIGS. 6, 7A, and 7B are schematic diagrams illustrating examples of manner of fixing a lid and a container main body in the second embodiment. As for a clamping means for fixing the lid 30 and the container main body 10, a screw 41 or a seal tape 43 may be used as shown in FIG. 6 or 7B, respectively, or an L-shaped hook 42 which is attached beforehand on the side of the container main body 10 may be turned so as to lock the lid 30 as shown in FIG. 7A. In the case where the screw 41 is used for fixing, it is possible to exchange an inner semiconductor laser module 3 easily upon opening the lid 30 by removing the screw 41. Likewise, the replacement of an inner semiconductor laser module 3 is easily made in the case of L-shaped hook 42.

Thus, when the lid 30 is made of a hard board material of high rigidity, the processing and treatment of the lid 30 become easy. Also, it is advantageous that various types of sealing means can be used.

While this invention has been described in connection with what is presently considered to be the most practical and preferred embodiments, the invention is not limited to the disclosed embodiments, but on the contrary, is intended to cover various modifications and equivalent arrangements included within the spirit and scope of the appended claims.

For example, the lid 20 may be formed with a resinous film and the lid 20 may be attached directly to the container main body 20 without providing the frame part. With a synergy effect, more improvement of the sealing can be attempted. The cooling means may be other cooling means than the Peltier device.

The entire disclosure of Japanese Patent Application No. 20004-229028 filed on Aug. 5, 2004 including specification, claims drawings and summary are incorporated herein by reference in its entirety.

What is claimed is:

1. A semiconductor laser device comprising:
semiconductor laser modules;
a container main body accommodating the semiconductor laser modules and having an opening for taking out a semiconductor laser module outside;
a lid provided at the opening in an openable and closable manner; and
a means for cooling the semiconductor laser modules.

2. A semiconductor laser device according to claim 1,
wherein a desiccant is provided in the container main body.

3. A semiconductor laser device according to claim 1,
wherein a temperature sensor and a humidity sensor are provided in the container main body.

4. A semiconductor laser device according to claim 1,
wherein at least a part of the lid is comprised of a resinous film.

5. A semiconductor laser device according to claim 4,
wherein the resinous film has a moisture permeability coefficient of 0.5 g/(m²day) or less.

6. A semiconductor laser device according to claim 4,
wherein the resinous film has flexibility of being transformed according to change in the inner gas pressure of the container main body.

7. A semiconductor laser device according to claim 1,
wherein the lid is made of a hard board material of high rigidity.

8. A semiconductor laser device according to claim 1,
further comprising a sealing means provided between the lid and the container main body.

9. A semiconductor laser device according to claim 8,
wherein the sealing means is made of one of, or two or more combinations of, a grease, a paste-like sealing material, a sealing ring, and a sealing tape.

10. A semiconductor laser device according to claim 1,
wherein the container main body is made of a metallic material and the inside of the container main body is filled with a gas.
